(19) United States
(12) Patent Application Publication
(10) Pub. No.: US 2024/0161377 A1
(43) Pub. Date: May 16, 2024

(54) PHYSICS-BASED SIMULATION OF HUMAN CHARACTERS IN MOTION

(71) Applicant: NVIDIA Corporation, Santa Clara, CA (US)

(72) Inventors: Zhengyi Luo, Pittsburgh, PA (US); Jason Peng, Vancouver (CA); Sanja Fidler, Toronto (CA); Or Litany, Sunnyvale, CA (US); Davis Winston Rempe, Redwood City, CA (US); Ye Yuan, Santa Clara, CA (US)

(73) Assignee: NVIDIA Corporation, Santa Clara, CA (US)

(21) Appl. No.: 18/194,116

(22) Filed: Mar. 31, 2023

Related U.S. Application Data
(60) Provisional application No. 63/424,593, filed on Nov. 11, 2022.

(51) Int. Cl. G06T 13/40; G06N 3/006

(52) U.S. Cl. CPC G06T 13/40; G06N 3/006

(57) ABSTRACT

In various examples, systems and methods are disclosed relating to generating a simulated environment and update a machine learning model to move each of a plurality of human characters having a plurality of body shapes, to follow a corresponding trajectory within the simulated environment as conditioned on a respective body shape. The simulated human characters can have diverse characteristics (such as gender, body proportions, body shape, and so on) as observed in real-life crowds. A machine learning model can determine an action for a human character in a simulated environment, based at least on a humanoid state, a body shape, and task-related features. The task-related features can include an environmental feature and a trajectory.

### RELATED APPLICATIONS

The present application claims the benefit of and priority to U.S. Provisional Application No. 63/424,593, filed Nov. 11, 2022, the disclosure of which is incorporated herein by reference in its entirety.

### BACKGROUND

Machine learning models, such as neural networks, can be used to simulate movement of agents in environments, such as for pedestrian movements in simulated environments. However, various models may lack realism with respect to movements, or may lack the ability to determine movements in a manner that can respond to user inputs, such as introduced obstacles or complex environments and scenarios.

### SUMMARY

Embodiments of the present disclosure relate to systems and methods for creating simulated human characters and synthesizing diverse characteristics and life-like behaviors within the context of complex simulated environments (e.g., urban areas, city environments, and so on). Large and complex scenes can be created in simulated environments by populating simulated human characters that follow trajectories determined using a trajectory planner while producing physically realistic pedestrian behaviors. Simulated human characters can be controlled to traverse diverse terrain types while following a path, such as a predetermined 2-dimensional (2D) path. The simulated human characters can have diverse characteristics (such as gender, body proportions, body shape, and so on) as observed in real-life crowds. The simulated human characters can avoid obstacles including other simulated characters.

Unlike conventional methods in which each individual simulated human character is not aware of each other and collide unrealistically, the present disclosure enables simultaneously controlling multiple simulated human characters with the diverse characteristics to realistically follow trajectories. Social groups can be created for the simulated human characters in a simulated environment, where simulated human characters in a social group can be aware of and interact and/or collide with one another. Accordingly, the simulated human characters in a simulated environment can interact with the simulated environment (e.g., the objects, vehicles, and scenes therein), interact with other simulated human characters, and are aware of close-by agents.

At least one aspect relates to a processor. The processor can include one or more circuits to determine, using a machine learning model, an action for a first human character in a first simulated environment, based at least on a humanoid state, a body shape, and task-related features. The task-related features can include an environmental feature and a first trajectory.

The machine learning model can be updated to move each of a plurality of human characters to follow a respective trajectory within a second simulated environment based at least on a first reward determined according to differences between simulated motion of each of the plurality of human characters and motion data for locomotion sequences determined from movements of real-life humans, and a second reward for the machine learning model moving each of the plurality of human characters to follow a respective trajectory based at least on a distance between each of the plurality of human characters and the respective trajectory.

The environmental feature can include at least one of a height map for the simulated environment and a velocity map for the simulated environment. The first trajectory can include 2D waypoints. The one or more circuits can transform, using a task feature processor, the environmental features into a latent vector and compute, using an policy network, the action based at least on the humanoid state, the body shape, and the latent vector. The task feature processor can include a convolution neural network (CNN). The policy network can include a multilayer perceptron (MVLP).

At least one aspect relates to a processor. The processor can include one or more circuits to generate a simulated environment and update a machine learning model to move each of a plurality of human characters having a plurality of body shapes, to follow a corresponding trajectory within the simulated environment as conditioned on a respective body shape. Updating the machine learning model can include determining a first reward for the machine learning model moving a respective human character according to differences between simulated motion of the respective human character and motion data for locomotion sequences determined from movements of a respective real-life human, determining a second reward for the machine learning model moving of the respective human character to follow a respective trajectory based at least on a distance between the respective human character and the respective trajectory, and updating the machine learning model using the first reward and the second reward.

The plurality of human characters having the different body shapes are generated by randomly sampling a set of body shapes. Randomly sampling the set of body shapes can include randomly sampling genders and randomly sampling body types. The one or more circuits can determine an initial body state of each of the plurality of human characters by randomly sampling a set of body states and determine an initial position of each of the plurality of human characters by randomly sampling a set of valid starting points in the simulated environment. Generating the simulated environment can include randomly sampling a set of simulated environments that includes terrains with different terrain heights.

The one or more circuits can generate the trajectory. Generating the trajectory can include randomly sampling a set of trajectories, the set of trajectories having different velocities and turn angles. The machine learning model can be updated using goal-conditioned reinforcement learning. Updating the machine learning model to move each of the plurality of human characters to follow the respective trajectory within the simulated environment can include determining a penalty for an energy consumed by the machine learning model in moving the each of the plurality of human characters to follow the respective trajectory, the energy including a joint torque and a joint angular velocity and updating the machine learning model using the first reward, the second reward, and the penalty.

Updating the machine learning model to move each of the plurality of human characters to follow a respective trajectory within the simulated environment can include determining a motion symmetry loss for the simulated motion of the each of the plurality of human characters. The machine learning model can be updated using the first reward, the second reward, and the motion symmetry loss.

Updating the machine learning model to move each of the plurality of human characters to follow a trajectory within the simulated environment can include determining that a termination condition has been satisfied. The termination condition can include one of a first human character of the plurality of human characters colliding with a second human character of the plurality of human characters, the first human character colliding with an object of the simulated environment, or the first human character colliding with a terrain of the simulated environment.

At least one aspect relates to a method. The method can include determining, using a machine learning model, an action for a first human character in a first simulated environment, based at least on a humanoid state, a body shape, and task-related features. The task-related features can include an environmental feature and a first trajectory.

The method can include updating the machine learning model to move each of a plurality of human characters to follow a respective trajectory within a second simulated environment based at least on a first reward determined according to differences between simulated motion of each of the plurality of human characters and motion data for locomotion sequences determined from movements of real-life humans, and a second reward for the machine learning model moving each of the plurality of human characters to follow a respective trajectory based at least on a distance between each of the plurality of human characters and the respective trajectory. The method can include transforming, using a task feature processor, the environmental features into a latent vector, and computing, using a policy network, the action based at least on the humanoid state, the body shape, and the latent vector.

The processors, systems, and/or methods described herein can be implemented by or included in at least one of a system associated with an autonomous or semi-autonomous machine (e.g., an in-vehicle infotainment system); a system for performing simulation operations; a system for performing digital twin operations; a system for performing light transport simulation; a system for performing collaborative content creation for 3D assets; a system for performing deep learning operations; a system implemented using an edge device; a system implemented using a robot; a system for generating or presenting virtual reality (VR) content, augmented reality (AR) content, and/or mixed reality (MR) content; a system for performing conversational AI operations; a system for performing generative AI operations using a large language model (LLM), a system for generating synthetic data; a system incorporating one or more virtual machines (VMs); a system implemented at least partially in a data center; or a system implemented at least partially using cloud computing resources.

### BRIEF DESCRIPTION OF THE DRAWINGS

The present systems and methods for controllable trajectory generation using neural network models are described in detail below with reference to the attached drawing figures, wherein:

FIG. 1 is a flow diagram illustrating creating simulated human characters and synthesizing diverse characteristics and life-like behaviors within the context of simulated environments, in accordance with some embodiments of the present disclosure;

FIG. 2 is a flow diagram illustrating determining an action of a human character using a policy network, in accordance with some embodiments of the present disclosure;

FIG. 3 is a representation of a simulated environment, in accordance with some embodiments of the present disclosure;

FIG. 4 is a representation of motion data included in the motion dataset, in accordance with some embodiments of the present disclosure;

FIG. 5 is a representation of humanoid states (right) and corresponding environment feature defining the simulated environment, in accordance with some embodiments of the present disclosure;

FIG. 6 is a representation of human characters in respective humanoid states in the simulated environment at a moment in time during training, in accordance with some embodiments of the present disclosure;

FIG. 7 is a flow diagram showing a method for training a machine learning model for moving a human character, in accordance with some embodiments of the present disclosure;

FIG. 8 is a flow diagram showing a method for deploying a machine learning model for moving a human character, in accordance with some embodiments of the present disclosure;

FIG. 9 is a block diagram of an example content streaming system suitable for use in implementing some embodiments of the present disclosure;

FIG. 10 is a block diagram of an example computing device suitable for use in implementing some embodiments of the present disclosure; and

FIG. 11 is a block diagram of an example data center suitable for use in implementing some embodiments of the present disclosure.

### DETAILED DESCRIPTION

Simulated human characters are important in various applications that leverage simulations. For example, in autonomous driving simulation applications in which an autonomous driver (e.g., an AI driver) is trained to avoid collision with the simulated human characters. Conventional methods of simulated human trajectory generation and forecast focus on modeling 2D human trajectories from a bird's-eye view, treating simulated human characters as 2D disks and failing to consider fine-grained details of underlying motion of the human model, such as variations in shapes and sizes of the human bodies. Conventional methods also do not consider physics and low-level interaction between simulated human characters and the environment (such as walking on uneven terrain, climbing stairs, and responses to perturbations). Conventional methods for human motion synthesis in driving simulation applications are primarily kinematic models, which more or less just play back existing motion clips. This can limit the diversity of behaviors that can be synthesized by these kinematic models. Physics-based models such as those described herein can use a physics simulation to synthesize more diverse data, which improve training of models for these downstream applications.

In some embodiments, a learning framework referred to as Pedestrian Animation ControllER (PACER) is provided to take into account the diverse characteristics of simulated human characters, terrain traversal, and social groups. For example, a unified reinforcement learning system can include an Adversarial Motion Prior (AMP) and motion symmetry loss. A character control system based on the adversarial motion prior and includes a discriminator as motion prior to guide a humanoid controller to produce natural human motions. The discriminator can be trained using a motion dataset (e.g., motion capture data) to differentiate between real and generated human motion. The motion dataset can be derived from the Archive of Motion Capture As Surface Shapes (AMASS) dataset, video data (e.g., broadcast data converted into motion capture data), pose estimation data, and so on. The discriminator is used to provide reward signals to the motion controller, for which an objective is to fool the discriminator. The motion symmetry loss is incorporated to enforce symmetrical motion and reduce limping, thus improving locomotion quality.

During training, different types of terrain (e.g., slopes, stairs, rough terrain, and obstacles) are sampled randomly. Simulated agents are tasked to follow predefined trajectories (e.g., defined by 2D waypoints in bird's-eye view) traversing the terrains and avoiding obstacles. A height map is used as terrain observation. Starting locations and 2D paths are randomly sampled. By randomly sampling diverse and challenging terrain types for training, the agents generalize to complex and unseen environments. To model social groups, the characters' observation space is augmented with states of 5 closest agents who are within a radius (e.g., 10 meters).

With regard to automatic character generation and motion sampling, an automatic character creation process that creates capsule-based humanoids for simulation purposes is provided. Body shapes are randomly sampled from the small motion dataset (e.g., AMASS dataset) and condition the policy on the body shapes and gender parameters. To obtain human motion paired with different body shapes, motions from the database are randomly sampled, and motion characteristics (e.g., joint positions and velocities) are recomputed based on the randomly sampled human body.

The systems and methods described herein may be used for a variety of purposes, by way of example and without limitation, for synthetic data generation, machine control, machine locomotion, machine driving, model training, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI with large language models, light transport simulation (e.g., ray-tracing, path tracing, etc.), collaborative content creation for 3D assets, cloud computing and/or any other suitable applications.

Disclosed embodiments may be included in a variety of different systems such as systems for performing synthetic data generation operations, automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems implemented at least partially in a data center, systems for performing conversational AI operations, systems implemented with one or more LLMs, systems for performing light transport simulation, systems for performing collaborative content creation for 3D assets, systems implemented at least partially using cloud computing resources, and/or other types of systems.

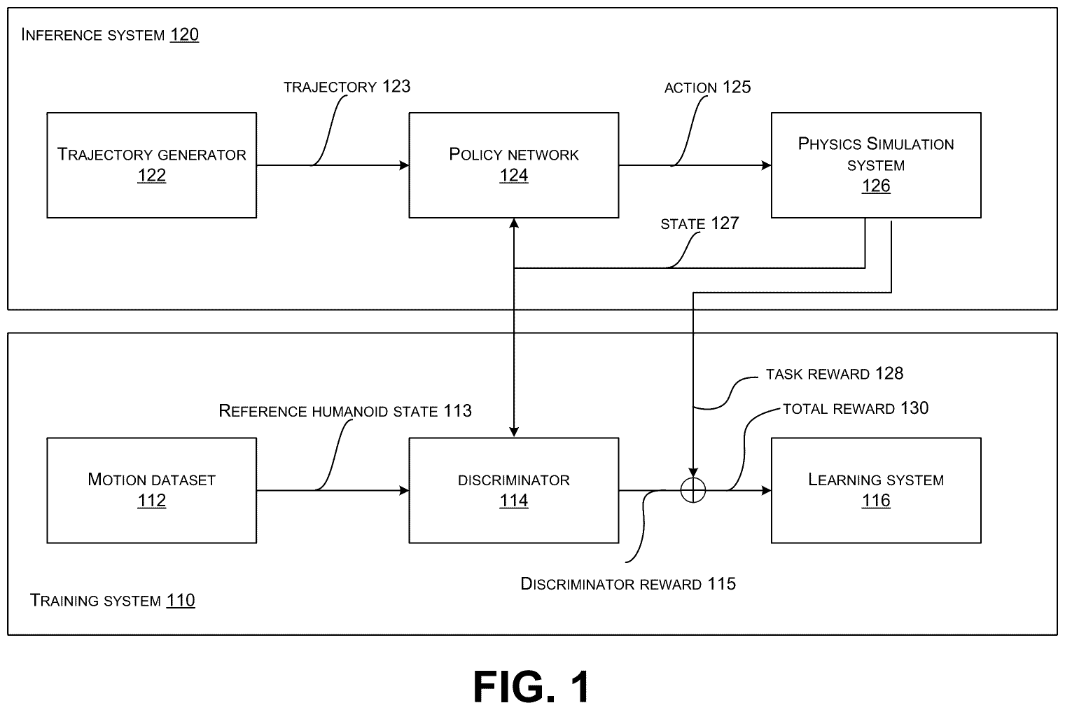

FIG. 1 is a block diagram illustrating an example flow for creating simulated human characters and synthesizing diverse characteristics and life-like behaviors within the context of simulated environments, according to various embodiments. The flow shown in FIG. 1 can be implemented using a training system 110 and an inference system 120. The training system 110 includes a motion dataset 112, a discriminator 114, and a learning system 116. The inference system 120 includes a trajectory generator 122, a policy network 124, and a physics simulation system 126. The inference system 120 executes the trajectory 123 of a human character in the physics simulation system 126. In some examples, the human character is generated to conform to Skinned Multi-Person Linear (SMPL).

It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. The systems described herein (e.g., the systems 110 and 120) can include any function, model (e.g., machine learning model), operation, routine, logic, or instructions to perform functions as described herein.

In some arrangements, the trajectory generator 122 is configured to generate a trajectory 123, referred to as τ. The trajectory 123 can be discretized into various steps at various points in time, where the trajectory at a step (e.g., at a given point in time) can be characterized as τₜ. A given trajectory 123 can be generated for each of at least one human character (e.g., human actors, humanoids, simulated humans, agents, and so on) in a simulated environment. Each trajectory 123 can include two or more 2D waypoints (e.g., two or more sets of 2D coordinates) within a simulated environment (e.g., a 3D simulated environment), in some examples. In some examples, each trajectory 123 can include two or more 3D waypoints (e.g., two or more sets of 3D coordinates) within a simulated environment. In some examples, the trajectory generator 122 can sample a plurality of trajectories to generate the trajectory 123. For example, the trajectory generator 122 can randomly generate velocities and turn angles over a period of time, where the aggregation of such velocities and turn angles over time correspond to the trajectory 123. In some examples, the velocity is limited to be in between [0, 3] m/s and acceleration is limited to be between [0, 2] m/s².

Examples of the trajectory generator 122 include the systems described in U.S. patent application Ser. No. 18/193,982, titled “REALISTIC, CONTROLLABLE AGENT SIMULATION USING GUIDED TRAJECTORIES AND DIFFUSION MODELS,” filed Mar. 31, 2023, the entire content of which is incorporated herein by reference in its entirety.

A simulated environment can be a computer-implemented environment having visual aspects and can include or be derived from a scan (e.g., photographic reconstruction, LiDAR reconstruction, and other scans), a neural reconstruction, or an artist-created mesh of a scene. A simulated environment can include stationary objects and dynamic objects. Stationary objects can include terrain features, structures, ground, and so on. Dynamic objects can include human characters, vehicles, mobile objects, and so on. The simulated environment can be defined by at least one environment feature oₜ at a given step or point in time. The environment feature can include one or more of a height map (e.g., a rasterized local height map, a global height map, and so on) of the simulated environment or scene, a velocity map for the dynamic objects in the simulated environment or scene, and so on. In some examples, the environment feature has a size defined by oₜ∈R64×64×3. Accordingly, during training, random terrains are generated. For example, stairs, slopes, uneven terrains, and obstacles including of random polygons can be created using different heights identified in the height map. The trajectory 123 and the environment feature oₜ can be collectively referred to as task-related features.

In some examples, the environment feature includes a first channel corresponding to a terrain height map relative to a human character root height. The environment feature can include a second channel corresponding to a 2D linear velocity of the human character in a first direction (e.g., an x direction) in an egocentric coordinate system for the human character. The environment feature can include a third channel corresponding to a 2D linear velocity of the human character in a second direction (e.g., a y direction) in an egocentric coordinate system for the human character. In some examples, the map corresponds to a 4 m×4 m square area centered at the root of the human character, sampled on an evenly spaced grid. An example trajectory, denoted as τₛ∈R10×2 includes the trajectory 123 for the next 5 seconds sampled at 0.5 s intervals (e.g., t=0.5, t=1, t=1.5, . . . , t=5).

The policy network 124 generates an action 125 (referred to as αₜ at a given step or point in time) for a human character following the trajectory 123. The action 125 includes realistic human motions for the human character while following the trajectory 123. The policy network 124 can be referred to as a machine learning model, a PACER policy network, a policy engine, an action policy network, and so on. The policy network 124 includes at least one policy (referred to as π_{PACER}) or model that can be trained using the training system 110. In order to provide a controller that can simulate crowds in realistic 3D scenes (e.g., the simulated environments), the human characters described herein are made to be terrain-aware and socially aware of other mobile objects, and to support diverse body types.

In some arrangements, the policy network 124 includes or uses at least one control policy conditioned on one or more of the state of the simulated character (referred to as hₜ at a given step or point in time), environmental features (referred to as or at a given step or point in time), and body type β. The at least one policy π_{PACER} can be updated, trained, or learned by the learning system 116 using goal-conditioned reinforcement learning according to a total reward rₜ at a given step or point in time. The goal can be stated as:

τₛ:π_{PACER}(αₜ|hₜ,oₜ,β,τₛ) (4)

In some examples, the task is formulated as a Markov Decision Process (MDP) defined by a tuple:

M= [symbol] S,A, [symbol] ,R,γ [symbol] (2),

where S refers to states, A refers to actions, [symbol] refers to transition dynamics, R refers to reward function, and γ refers to discount factor.

The inputs to the policy network 124 include the environment feature to provide a human character with information about its surroundings in the simulated environment. To allow for social awareness, nearby human characters can be represented as a simplified shape (e.g., cuboid) and rendered on a global height map at runtime. Accordingly, each human character views other human characters as dynamic obstacles to avoid. Obstacle and interpersonal avoidance are learned by using obstacle collision as a termination condition as described herein.

The inputs to the policy network 124 further include a body shape or body morphology of the human character, defined by body parameters β. The different body shapes can be sampled from a database of different body types, such as the archive of motion capture as surface shapes (AMASS) dataset. The different body types can be sampled using criteria such as age, gender, body type, and so on. By conditioning and training with different body parameters β as described herein, the policy network 124 learns to adapt to characters with diverse morphologies. Both the policy network 124 and the discriminator 114 can be updated, configured, or trained based on different SMPL gender and body parameters β.

The physics simulation system 126 applies inputs including the action 125 for each of at least one human character and outputs a state 127 (referred to as a combination of hₜ, oₜ, β) corresponding to the simulated motion of each of the at least one human character. The state 127 (at t) is applied as an input into the policy network 124 for determining a subsequent action 125 (at t+1). The state 127 is applied as input to the discriminator 114. Accordingly, the policy network 124 can determine the action at t+1 (e.g., αₜ₊₁) based at least on the humanoid state hₜ and the task-related features (e.g., the trajectory τₜ and the environment feature oₜ) at t, and the body shape β.

In some embodiments, the physics simulation system 126 can generate a task reward (referred to as rₜ^{τ}) for the at least one policy of the policy network 124 moving a human character to follow the trajectory 123 of the human character based at least on a distance between the human character and the trajectory 123. The task reward can be referred to as a second reward. The physics simulation system 126 can determine the task reward by determining the distance between a center cₜ (at a given step or point in time) of a human character on a plane (e.g., the x-y plane) and the trajectory 123. In some examples, the trajectory 123, which is a 2D trajectory, lies on the same plane. For example, the task reward can be determined using:

rₜ^{τ}=exp(−2×∥cₜ−τₜ∥²) (3).

The motion dataset 112 includes motion data for locomotion sequences determined from movements of real-life humans. That is, the motion dataset 112 includes information (e.g., motion clips) recorded or otherwise captured from real-life human actors, such as motion capture data. The locomotion sequences can be sampled or otherwise selected from locomotion sequences in a dataset (e.g., the AMASS dataset). The locomotion sequences can include human characters walking and turning at various speeds, as well as walking up and down elevations (e.g., stairs, slopes, and so on).

The motion data included in the motion dataset 112 contains a reference humanoid state 113 (referred to as [symbol] at a given step or point in time) of a human character. In some embodiments, the reference humanoid state 113 can be generated using forward kinematics based on the sampled poses and a kinematic tree of the human character. In the beginning of a number of episodes (e.g., 250 episodes), the training system 110 randomly samples a new batch of pose sequences from the motion dataset 112 of human characters having diverse body types and creates new reference humanoid states. The reference states of diverse body types and motions can accordingly be obtained.

The human characters can be initialized by randomly sampling a body state h₀ from a walkable map corresponding to all locations suitable as valid starting points. A start point can be valid if, for example, the start point is not above an object classified as an obstacle.

The discriminator 114 (referred to as D(hₜ, αₜ)) updates (e.g., trains) the at least one policy implemented in the policy network 124 to generate motions that are similar to the movement patterns contained in the motion dataset 112. The discriminator 114 updates the at least one policy using, for example, Adversarial Motion Prior (AMP). For example, the discriminator 114 can determine a motion style reward (referred to as rₜ^{amp}) for updating (e.g., training) the at least one policy of the policy network 124 according to differences between simulated motion of a human character and the motion data for locomotion sequences determined from movements of real-life humans. For example, the discriminator 114 can determine the motion style reward for training the at least one policy of the policy network 124 based on a detection of differences between simulated motion of a human character and the motion data for locomotion sequences determined from movements of real-life humans. For example, the discriminator 114 can determine the motion style reward for training the at least one policy of the policy network 124 based on discrimination of differences between simulated motion of a human character and the motion data for locomotion sequences determined from movements of real-life humans. Examples of the simulated motion include the state 127 outputted from the physics simulation system 126, the humanoid state of the simulated character (referred to as hₜ at a given step or point in time), and so on. Examples of the motion data for locomotion sequences determined from movements of real-life humans include the reference humanoid state 113.

The motion style reward can be referred to as a first reward. The discriminator 114 can determine the motion style reward using a number (e.g., 2, 10, 20, 100, and so on) of steps of aggregated humanoid states hₜ of a human character.

The training system 110 can determine a total reward 130, which serves as an input to the learning system 116. In some examples, the total reward rₜ can be a sum or combination of the first reward (the motion style reward) and the second reward (the task reward):

rₜ=rₜ^{amp}+rₜ^{τ} (4).

In some examples, the first reward and the second reward can be weighted.

In some examples, the total reward 130 can be a sum or combination of the first reward, the second reward, and a penalty/third reward (e.g., an energy penalty rₜ^{energy}):

rₜ=rₜ^{amp}+rₜ^{τ}+rₜ^{energy} (5).

The energy penalty can be determined using, for example:

−0.0005·Σ_{j∈joints}|μⱼ\dot{q}ⱼ|² (6)
where μⱼ corresponds to the joint torque, and \dot{q}ⱼ corresponds to the joint angular velocity. In some examples, the first reward, the second reward, and the penalty can be weighted. In some examples, the total reward 130 can include at least one of the first reward, the second reward, and the penalty.

In some examples, a loss/fourth reward (e.g., a motion-symmetry loss L_{sym}(θ)) can be defined as

L_{sym}(θ)=∥π_{PACER}(hₜ,oₜ,β,τₛ)−(Φ_{α}(π_{PACER}(Φₛ(hₜ,oₜ,β,τₛ)))∥² (7),
where Φₛ mirrors the state along the character's sagittal plane, and Φ_{α} mirrors the action along the character's sagittal plane. The motion symmetry loss can be considered in training to mitigate artifacts arising from asymmetric gaits during training, such as limping, especially at lower speeds. This may be cause by a small temporal window used in AMP (e.g., 10 frames), which may not be sufficient to generate symmetric motion. The complexity in symmetric control of motion grows exponentially as the degrees of freedom increases (e.g., from 28 to 69, which is in AMP). Symmetry loss can be caused by difficult in the discriminator 114 to discern asymmetric gaits. The motion symmetry loss can be used to update the policy to generate symmetric motions of the human character, thus leading to natural gaits. In some examples, the motion symmetry loss is not a reward and is directly defined on the policy output by the policy network 124. As the motion symmetry loss can be computed in an end-to-end differentiable fashion, the motion symmetry loss can be directly optimized through stochastic gradient descent (SGD).

The learning system 116 can train, update, or configure one or more of the policy network 124 and the discriminator 114. The policy network 124 and the discriminator 114 can each include machine learning models or other models that can generate target outputs based on various types of inputs. The policy network 124 and the discriminator 114 can each include one or more neural networks, transformers, recurrent neural networks (RNNs), long short-term memory (LSTM) models, CNNs, other network types, or various combinations thereof. The neural network can include an input layer, an output layer, and/or one or more intermediate layers, such as hidden layers, which can each have respective nodes. The learning system 116 can train/update the neural network by modifying or updating one or more parameters, such as weights and/or biases, of various nodes of the neural network responsive to evaluating estimated outputs of the neural network.

For example, the learning system 116 can be used to update, configure, or train the at least one policy of the policy network 124 using goal-conditioned reinforcement learning, where the goal is defined according to expression (1), and the task is defined by a tuple according to expression (2). In some examples, the learning system 116 includes proximal policy optimization (PPO) that can determine the optimal policy π_{PACER}. The state S (including the state 127 or the humanoid state hₜ) and transition dynamics [symbol] (including environmental features oₜ) are calculated by the environment (e.g., the physics simulation system 126) based on the current simulation and goal τₛ. The reward R (including the total reward 130, rₜ) is calculated by the discriminator 114. The action A (e.g., the action 125, αₜ) is computed by the policy π_{PACER}. The objective of the policy is to maximize the discounted return , defined for example by:

[symbol]

[Σₜ₌₁^{T}γ^{t-1}rₜ] (8)
where rₜ is the total reward 130 per step (e.g., at t).

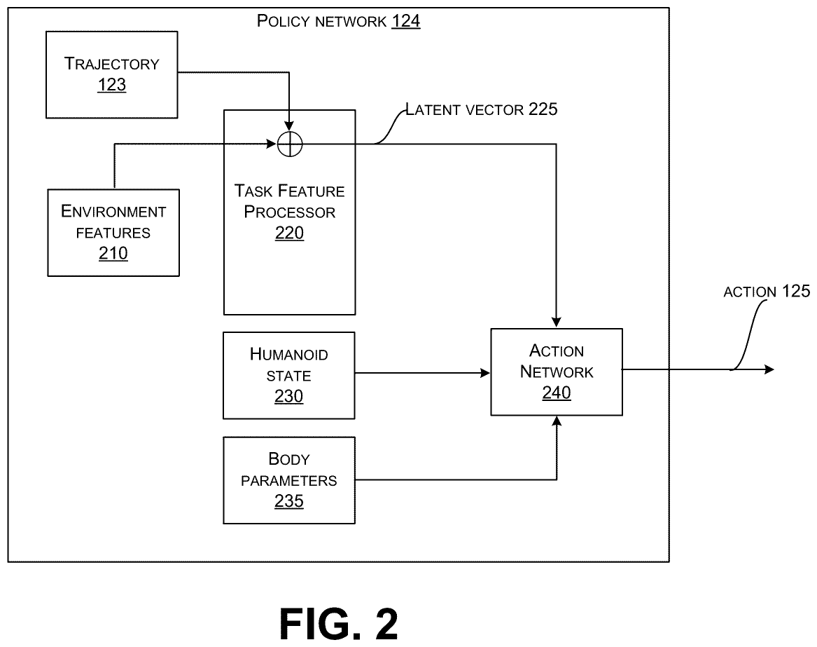

FIG. 2 is a flow diagram illustrating determining the action 125 of a human character using the policy network 124, in accordance with some embodiments. In the example shown in FIG. 2, the policy network 124 includes one or more neural networks 210, a task feature processor 220, and an action network 240. In some embodiments, to accommodate high dimensionality of the environmental features, the policy network 124 can include the task feature processor 220 referred to as E_{PACER} (ϕₜ|oₜ, τₛ), and an action network 240 referred to as π_{PACER}^{A} (αₜ|ϕₜ, hₜ, β) or π_{PACER}^{A} (ϕₜ, t).

In some embodiments, the task feature processor 220 can transform the task-related features (including for example, the environmental features 210 (e.g., oₜ) and the trajectory 123) into at least one latent vector 225 (referred to as task feature or ϕₜ at a given step or point in time), where an example of the latent vector 225 includes ϕₜ∈R²⁵⁶. Then, the action network 240 can compute the action 125 based on the humanoid state 230 (e.g., hₜ), the body parameters 235 (e.g., β), and the latent vector 225. Such policy network 124 can be represented as:

π_{PACER}(αₜ|hₜ,oₜ,β,τₛ) [symbol] π_{PACER}^{A}(E_{PACER}(oₜ,τₛ),hₜ,β) (10).

In some examples, the task feature processor 220 includes at least one neural network, such as a four-level CNN with a stride of 2, 16 filters, and a kernel size of 4. The task feature processor 220 can be implemented using other types of neural networks, such as transformers, recurrent neural networks (RNNs), deep neural networks (DNNs), long short-term memory (LSTM) models, or various combinations thereof. In some examples, the action network 240 can include an MLP, for example, with ReLU activations. In some examples, the MLP can include two layers, with 2048 and 1024 units.

In some examples, the policy in the policy network 124 can map to the Gaussian distribution over actions π_{PACER} (αₜ|hₜ, oₜ, β, τₛ)=N(μ(oₜ, hₜ, β, τₛ), Σ), with a fixed covariance matrix Σ. The action 1254 can include at least one action vector, each action vector αₜ∈R23×3 corresponds to the targets for actuated joints (e.g., the 23 actuated joints) on the SMPL human body. The discriminator 114 in some examples can shares the same architecture as the task feature processor 220, in some examples. In some examples, a value function V(νₜ|oₜ, hₜ, β, τₛ) shares the same architecture as the policy. A learned value function can predict the future rewards over a given Trajectory, where the guidance loss corresponding to the value function can include for example L=exp(−V(τₛ)). The value function uses as inputs oₜ, hₜ, β as input, which are fixed throughout denoising.

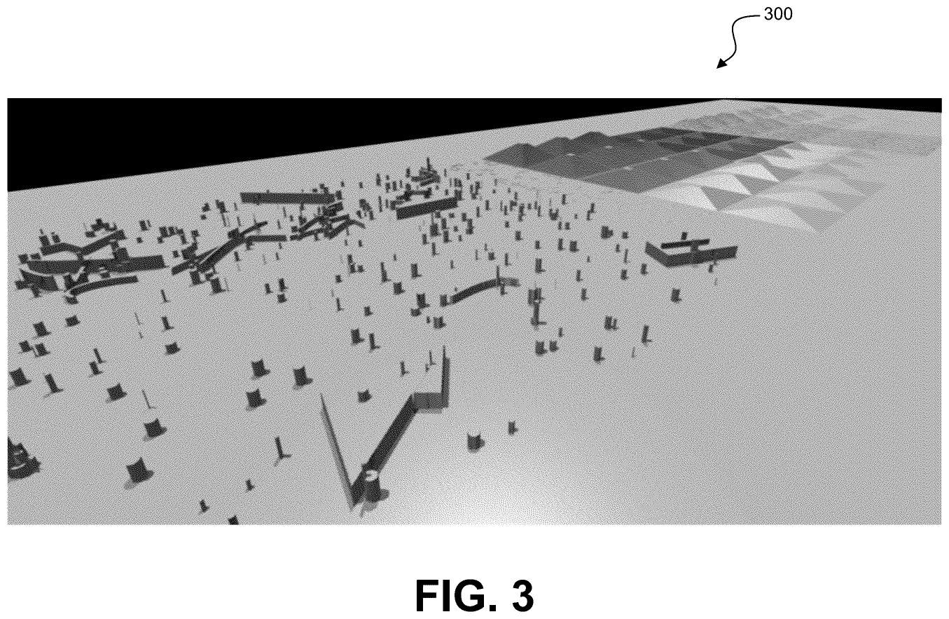

FIG. 3 is a representation of a simulated environment 300, in accordance with some embodiments of the present disclosure. The simulated environment 300 can include stationary objects and dynamic objects. The simulated environment 300 can be defined by one or more environment features, such as a height map, a velocity map for the dynamic objects in the simulated environment or scene, and so on. The appearances, shapes, and sizes of objects can be defined using the height relative to a base x-y plane, as specified in the height map.

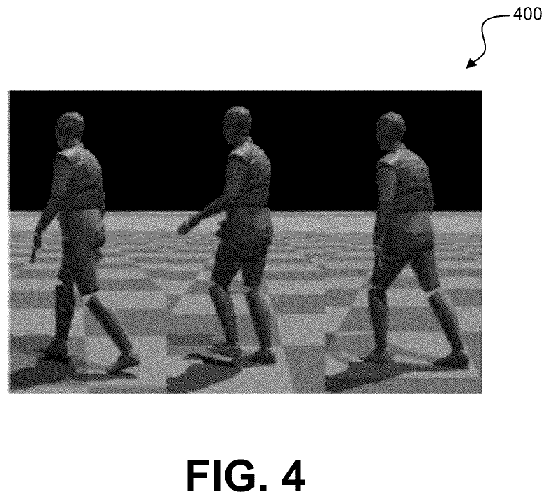

FIG. 4 is a representation of motion data 400 included in the motion dataset 112, in accordance with some embodiments of the present disclosure. The motion data 400 includes a locomotion sequence of three states corresponding to the movements of a real-life human. The states shown in FIG. 4 are referred to as reference humanoid states 113.

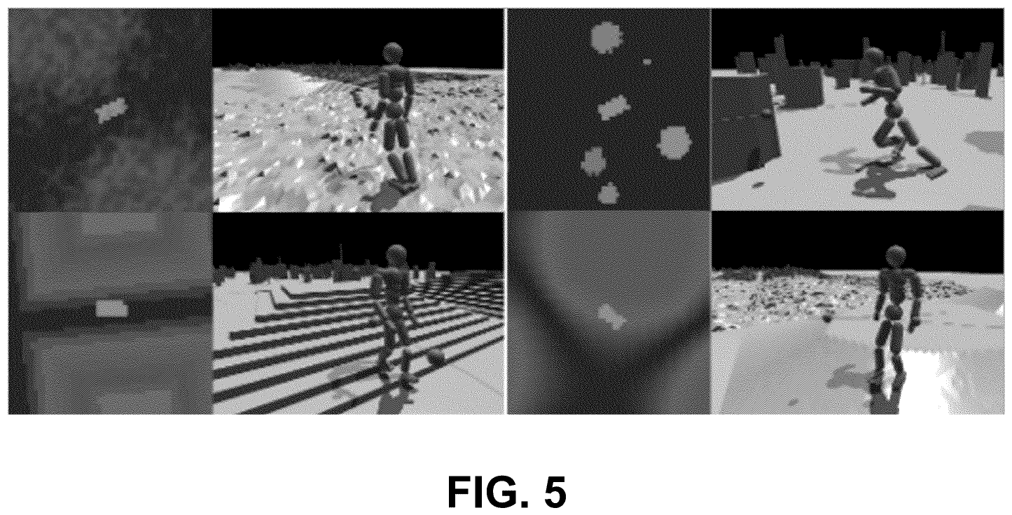

FIG. 5 is a representation of humanoid states and corresponding environment feature oₜ defining the simulated environment, in accordance with some embodiments of the present disclosure. As shown, four different humanoid states 230 at four respective points in time (e.g., t=1, 2, 3, 4, respectively) are shown, while a corresponding height map is shown to the left of each of the humanoid states 230. A humanoid state 230 can include a location in the simulated environment, velocity, orientation, joint locations, joint velocities, and so on of the human character.

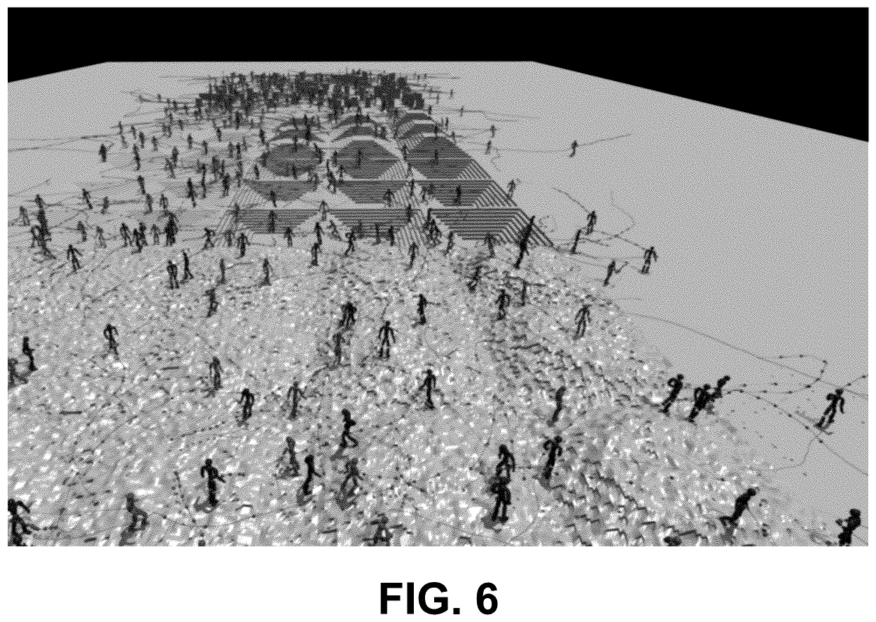

FIG. 6 is a representation of human characters in respective humanoid states 230 in the simulated environment at a moment in time during training, in accordance with some embodiments of the present disclosure. The policy network 124 can be updated, trained, or configured to move each of a large number of simulated human characters within the simulated environment using the action 125. The human characters shown in FIG. 6 each has a corresponding humanoid state 230 as the result of a determined action 125 at a moment in time. The humanoid state 230 for each human character can include a location in the simulated environment, velocity, orientation, joint locations, joint velocities, and so on of the human character.

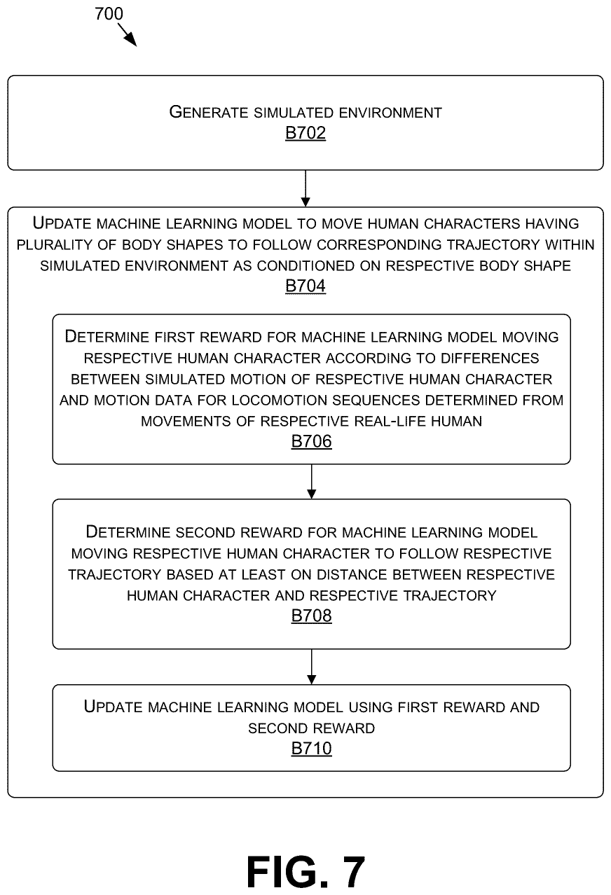

Now referring to FIG. 7, each block of method 700, described herein, comprises a computing process that may be performed using any combination of hardware, firmware, and/or software. For instance, various functions may be carried out by a processor executing instructions stored in memory. The method 700 may also be embodied as computer-usable instructions stored on computer storage media. The method 700 may be provided by a standalone application, a service or hosted service (standalone or in combination with another hosted service), or a plug-in to another product, to name a few. In addition, method 700 is described, by way of example, with respect to the systems of FIG. 1 and FIG. 2. However, this method 700 may additionally or alternatively be executed by any one system, or any combination of systems, including, but not limited to, those described herein. FIG. 7 is a flow diagram showing a method 700 for training a machine learning model for moving a human character, in accordance with some embodiments of the present disclosure.

At block B702, a simulated environment is generated or otherwise provided. The simulated environment can be defined using at least one environmental feature. In some examples, generating the simulated environment includes randomly sampling a set of simulated environments that include terrains with different terrain heights, covering slopes, uneven terrain, stairs (down), stairs (up), discrete, obstacles, and so on. In some examples, the trajectory generator 122 can generate the trajectory 123 by randomly sampling a set of trajectories, the set of trajectories having different velocities and turn angles.

At block B704, a machine learning model (e.g., the policy network 124) is updated (e.g., trained) to move each of a plurality of human characters having a plurality of body shapes, to follow a corresponding trajectory within the simulated environment as conditioned on a respective body shape. Block B704 includes blocks B706, B708, and B710.

In some embodiments, the plurality of human characters having the different body shapes are generated by randomly sampling a set of body shapes (e.g., from a database such as a AMASS dataset). In some examples, randomly sampling the set of body shapes includes randomly sampling genders and randomly sampling body types.

In some examples, the method 700 includes determining an initial body state of each of the plurality of human characters by randomly sampling a set of body states and determining an initial position of each of the plurality of human characters by randomly sampling a set of valid starting points in the simulated environment.

At block B706, a first reward (e.g., the motion style reward) is determined by the discriminator 114 for the machine learning model moving a respective human character according to differences between simulated motion of the respective human character and motion data for locomotion sequences determined from movements of a respective real-life human.

At block B708, a second reward (e.g., a task reward) is determined by the physics simulating system 126 for the machine learning model to move the respective human character to follow a respective trajectory 123 based at least on a distance between the respective human character and the respective trajectory.

At block B710, the learning system 116 can update (e.g., train) the machine learning model using the first reward and the second reward. In some examples, the machine learning model is updated using goal-conditioned reinforcement learning.

In some examples, updating the machine learning model to move each of the plurality of human characters to follow the respective trajectory within the simulated environment includes determining a penalty (e.g., energy penalty) for an energy consumed by the machine learning model in moving the each of the plurality of human characters to follow the respective trajectory. The energy consumed includes a joint torque and a joint angular velocity of a human character. The learning system 116 updates the machine learning model using the first reward, the second reward, and the penalty.

In some examples, updating the machine learning model to move each of the plurality of human characters to follow a respective trajectory within the simulated environment includes determining a motion symmetry loss for the simulated motion of the each of the plurality of human characters. The learning system 116 updates the machine learning model using the first reward, the second reward, and the motion symmetry loss. The learning system 116 can update the machine learning model using at least one of the first reward, the second reward, the energy penalty, or the motion symmetry loss.

In some examples, updating the machine learning model to move each of the plurality of human characters to follow a trajectory within the simulated environment includes determining that a termination condition has been satisfied. The termination condition includes one of a first human character of the plurality of human characters colliding with a second human character of the plurality of human characters, the first human character colliding with an object of the simulated environment, or the first human character colliding with a terrain of the simulated environment.

In some examples, the policy network 124 can be implemented or executed in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using a robot, a system for performing conversational AI operations, a system for performing generative AI operations using a LLM, a system for generating synthetic data, a system incorporating one or more VMs, a system implemented at least partially in a data center, or a system implemented at least partially using cloud computing resources.

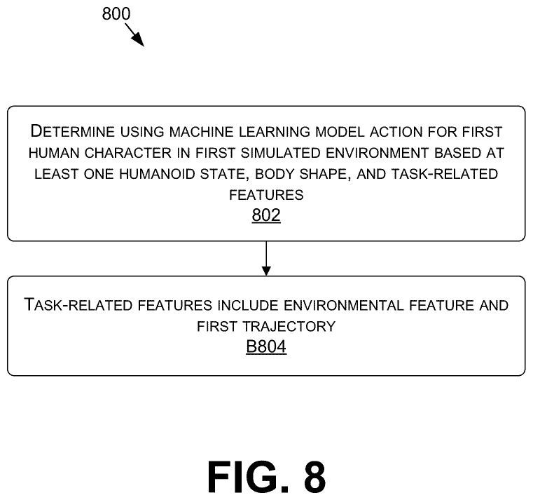

Now referring to FIG. 8, each block of method 800, described herein, comprises a computing process that may be performed using any combination of hardware, firmware, and/or software. For instance, various functions may be carried out by a processor executing instructions stored in memory. The method 800 may also be embodied as computer-usable instructions stored on computer storage media. The method 800 may be provided by a standalone application, a service or hosted service (standalone or in combination with another hosted service), or a plug-in to another product, to name a few. In addition, method 800 is described, by way of example, with respect to the systems of FIG. 1 and FIG. 2. However, this method 800 may additionally or alternatively be executed by any one system, or any combination of systems, including, but not limited to, those described herein. FIG. 8 is a flow diagram showing a method 800 for deploying a machine learning model (e.g., trained using the method 700) for moving a human character, in accordance with some embodiments of the present disclosure.

At block B802, the machine learning model (e.g., the policy network 124) determines an action for a first human character in a first simulated environment during deployment, based on one or more of a humanoid state, a body shape, and task-related features. At block B804, the task-related features include an environmental feature and a first trajectory generated for deployment. In some examples, the environmental feature includes at least one of a height map for the simulated environment and a velocity map for the simulated environment. The first trajectory includes 2D waypoints.

In some examples, the machine learning model is updated (e.g., trained) to move each of a plurality of second human characters to follow a respective trajectory within a second simulated environment during updating (e.g., training) based at least on a first reward (e.g., a Motion style reward) determined according to differences between simulated motion of each of the plurality of second human characters during updating (e.g., training) and motion data for locomotion sequences determined from movements of real-life humans, and a second reward (e.g., a task reward) for the machine learning model moving each of the plurality of second human characters to follow a respective trajectory during updating (e.g., training) based at least on a distance between each of the plurality of human characters and the respective trajectory.

In some examples, the task feature processor 220 transforms the environmental features into a latent vector. The action network 240 computes the action based at least on the humanoid state, the body shape, and the latent vector. The task feature processor 220 can include at least one CNN. The action network 240 includes a MLP.

In some examples, the policy network 124 can be implemented or executed in at least one of a control system for an autonomous or semi-autonomous machine, a perception system for an autonomous or semi-autonomous machine, a system for performing simulation operations, a system for performing digital twin operations, a system for performing light transport simulation, a system for performing collaborative content creation for 3D assets, a system for performing deep learning operations, a system implemented using an edge device, a system implemented using a robot, a system for performing conversational AI operations, a system for performing generative AI operations using a LLM, a system for generating synthetic data, a system incorporating one or more VMs, a system implemented at least partially in a data center, or a system implemented at least partially using cloud computing resources.

### Example Content Streaming System

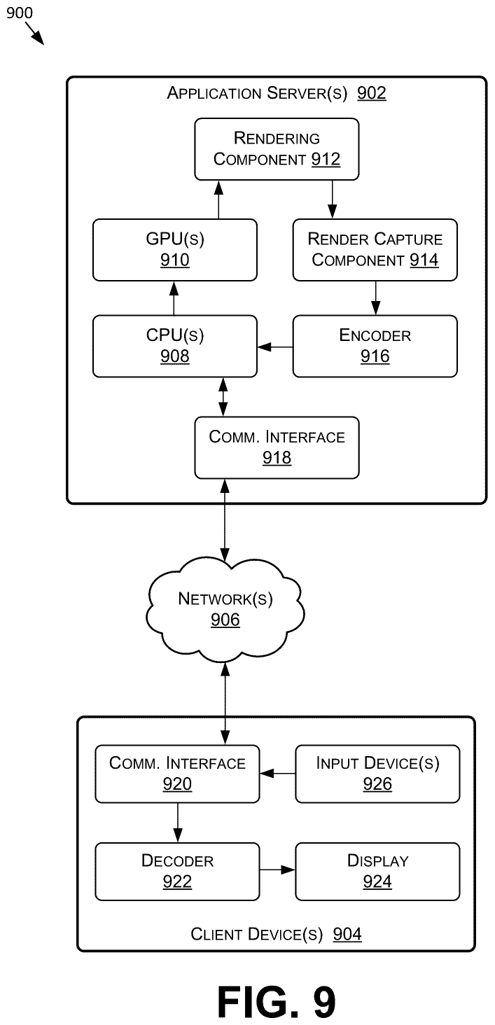

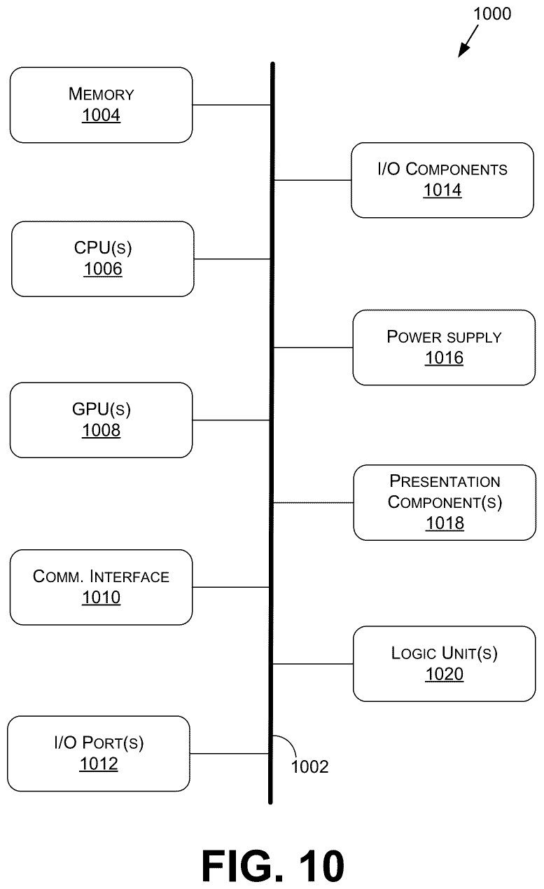

Now referring to FIG. 9, FIG. 9 is an example system diagram for a content streaming system 900, in accordance with some embodiments of the present disclosure. FIG. 9 includes application server(s) 902 (which may include similar components, features, and/or functionality to the example computing device 1000 of FIG. 10), client device(s) 904 (which may include similar components, features, and/or functionality to the example computing device 1000 of FIG. 10), and network(s) 906 (which may be similar to the network(s) described herein). In some embodiments of the present disclosure, the system 900 may be implemented to perform training of the machine learning model and runtime operations during employment. The application session may correspond to a game streaming application (e.g., NVIDIA GeFORCE NOW), a remote desktop application, a simulation application (e.g., autonomous or semi-autonomous vehicle simulation), computer aided design (CAD) applications, virtual reality (VR) and/or augmented reality (AR) streaming applications, deep learning applications, and/or other application types. For example, the system 900 can be implemented to receive input indicating one or more features of output to be generated using a neural network model, provide the input to the model to cause the model to generate the output, and use the output for various operations including display or simulation operations.

In the system 900, for an application session, the client device(s) 904 may only receive input data in response to inputs to the input device(s), transmit the input data to the application server(s) 902, receive encoded display data from the application server(s) 902, and display the display data on the display 924. As such, the more computationally intense computing and processing is offloaded to the application server(s) 902 (e.g., rendering—in particular ray or path tracing—for graphical output of the application session is executed by the GPU(s) of the game server(s) 902). In other words, the application session is streamed to the client device(s) 904 from the application server(s) 902, thereby reducing the requirements of the client device(s) 904 for graphics processing and rendering.

For example, with respect to an instantiation of an application session, a client device 904 may be displaying a frame of the application session on the display 1024 based on receiving the display data from the application server(s) 902. The client device 904 may receive an input to one of the input device(s) and generate input data in response. The client device 904 may transmit the input data to the application server(s) 902 via the communication interface 920 and over the network(s) 906 (e.g., the Internet), and the application server(s) 902 may receive the input data via the communication interface 918. The CPU(s) 908 may receive the input data, process the input data, and transmit data to the GPU(s) 910 that causes the GPU(s) 910 to generate a rendering of the application session. For example, the input data may be representative of a movement of a character of the user in a game session of a game application, firing a weapon, reloading, passing a ball, turning a vehicle, etc. The rendering component 912 may render the application session (e.g., representative of the result of the input data) and the render capture component 914 may capture the rendering of the application session as display data (e.g., as image data capturing the rendered frame of the application session). The rendering of the application session may include ray or path-traced lighting and/or shadow effects, computed using one or more parallel processing units—such as GPUs, which may further employ the use of one or more dedicated hardware accelerators or processing cores to perform ray or path-tracing techniques—of the application server(s) 902. In some embodiments, one or more virtual machines (VMs)—e.g., including one or more virtual components, such as vGPUs, vCPUs, etc.—may be used by the application server(s) 902 to support the application sessions. The encoder 916 may then encode the display data to generate encoded display data and the encoded display data may be transmitted to the client device 904 over the network(s) 906 via the communication interface 918. The client device 904 may receive the encoded display data via the communication interface 920 and the decoder 922 may decode the encoded display data to generate the display data. The client device 904 may then display the display data via the display 1024.

### Example Computing Device

FIG. 10 is a block diagram of an example computing device(s) 1000 suitable for use in implementing some embodiments of the present disclosure. Computing device 1000 may include an interconnect system 1002 that directly or indirectly couples the following devices: memory 1004, one or more central processing units (CPUs) 1006, one or more graphics processing units (GPUs) 1008, a communication interface 1010, input/output (I/O) ports 1012, input/output components 1014, a power supply 1016, one or more presentation components 1018 (e.g., display(s)), and one or more logic units 1020. In at least one embodiment, the computing device(s) 1000 may comprise one or more virtual machines (VMs), and/or any of the components thereof may comprise virtual components (e.g., virtual hardware components). For non-limiting examples, one or more of the GPUs 1008 may comprise one or more vGPUs, one or more of the CPUs 1006 may comprise one or more vCPUs, and/or one or more of the logic units 1020 may comprise one or more virtual logic units. As such, a computing device(s) 1000 may include discrete components (e.g., a full GPU dedicated to the computing device 1000), virtual components (e.g., a portion of a GPU dedicated to the computing device 1000), or a combination thereof.

Although the various blocks of FIG. 10 are shown as connected via the interconnect system 1002 with lines, this is not intended to be limiting and is for clarity only. For example, in some embodiments, a presentation component 1018, such as a display device, may be considered an I/O component 1014 (e.g., if the display is a touch screen). As another example, the CPUs 1006 and/or GPUs 1008 may include memory (e.g., the memory 1004 may be representative of a storage device in addition to the memory of the GPUs 1008, the CPUs 1006, and/or other components). In other words, the computing device of FIG. 10 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 10.

The interconnect system 1002 may represent one or more links or busses, such as an address bus, a data bus, a control bus, or a combination thereof. The interconnect system 1002 may be arranged in various topologies, including but not limited to bus, star, ring, mesh, tree, or hybrid topologies. The interconnect system 1002 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1006 may be directly connected to the memory 1004. Further, the CPU 1006 may be directly connected to the GPU 1008. Where there is direct, or point-to-point connection between components, the interconnect system 1002 may include a PCIe link to carry out the connection. In these examples, a PCI bus need not be included in the computing device 1000.

The memory 1004 may include any of a variety of computer-readable media. The computer-readable media may be any available media that may be accessed by the computing device 1000. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1004 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1000. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1006 may be configured to execute at least some of the computer-readable instructions to control one or more components of the computing device 1000 to perform one or more of the methods and/or processes described herein. The CPU(s) 1006 may each include one or more cores (e.g., one, two, four, eight, twenty-eight, seventy-two, etc.) that are capable of handling a multitude of software threads simultaneously. The CPU(s) 1006 may include any type of processor, and may include different types of processors depending on the type of computing device 1000 implemented (e.g., processors with fewer cores for mobile devices and processors with more cores for servers). For example, depending on the type of computing device 1000, the processor may be an Advanced RISC Machines (ARM) processor implemented using Reduced Instruction Set Computing (RISC) or an x86 processor implemented using Complex Instruction Set Computing (CISC). The computing device 1000 may include one or more CPUs 1006 in addition to one or more microprocessors or supplementary co-processors, such as math co-processors.

In addition to or alternatively from the CPU(s) 1006, the GPU(s) 1008 may be configured to execute at least some of the computer-readable instructions to control one or more components of the computing device 1000 to perform one or more of the methods and/or processes described herein. One or more of the GPU(s) 1008 may be an integrated GPU (e.g., with one or more of the CPU(s) 1006 and/or one or more of the GPU(s) 1008 may be a discrete GPU. In embodiments, one or more of the GPU(s) 1008 may be a coprocessor of one or more of the CPU(s) 1006. The GPU(s) 1008 may be used by the computing device 1000 to render graphics (e.g., 3D graphics) or perform general purpose computations. For example, the GPU(s) 1008 may be used for General-Purpose computing on GPUs (GPGPU). The GPU(s) 1008 may include hundreds or thousands of cores that are capable of handling hundreds or thousands of software threads simultaneously. The GPU(s) 1008 may generate pixel data for output images in response to rendering commands (e.g., rendering commands from the CPU(s) 1006 received via a host interface). The GPU(s) 1008 may include graphics memory, such as display memory, for storing pixel data or any other suitable data, such as GPGPU data. The display memory may be included as part of the memory 1004. The GPU(s) 1008 may include two or more GPUs operating in parallel (e.g., via a link). The link may directly connect the GPUs (e.g., using NVLINK) or may connect the GPUs through a switch (e.g., using NVSwitch). When combined together, each GPU 1008 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1006 and/or the GPU(s) 1008, the logic unit(s) 1020 may be configured to execute at least some of the computer-readable instructions to control one or more components of the computing device 1000 to perform one or more of the methods and/or processes described herein. In embodiments, the CPU(s) 1006, the GPU(s) 1008, and/or the logic unit(s) 1020 may discretely or jointly perform any combination of the methods, processes and/or portions thereof. One or more of the logic units 1020 may be part of and/or integrated in one or more of the CPU(s) 1006 and/or the GPU(s) 1008 and/or one or more of the logic units 1020 may be discrete components or otherwise external to the CPU(s) 1006 and/or the GPU(s) 1008. In embodiments, one or more of the logic units 1020 may be a coprocessor of one or more of the CPU(s) 1006 and/or one or more of the GPU(s) 1008.

Examples of the logic unit(s) 1020 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Image Processing Units (IPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1010 may include one or more receivers, transmitters, and/or transceivers that allow the computing device 1000 to communicate with other computing devices via an electronic communication network, included wired and/or wireless communications. The communication interface 1010 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1020 and/or communication interface 1010 may include one or more data processing units (DPUs) to transmit data received over a network and/or through interconnect system 1002 directly to (e.g., a memory of) one or more GPU(s) 1008. In some embodiments, a plurality of computing devices 1000 or components thereof, which may be similar or different to one another in various respects, can be communicatively coupled to transmit and receive data for performing various operations described herein, such as to facilitate latency reduction.

The I/O ports 1012 may allow the computing device 1000 to be logically coupled to other devices including the I/O components 1014, the presentation component(s) 1018, and/or other components, some of which may be built in to (e.g., integrated in) the computing device 1000. Illustrative I/O components 1014 include a microphone, mouse, keyboard, joystick, game pad, game controller, satellite dish, scanner, printer, wireless device, etc. The I/O components 1014 may provide a natural user interface (NUI) that processes air gestures, voice, or other physiological inputs generated by a user, such as to generate a driving signal for use by modifier 112, or a reference image (e.g., images 104). In some instances, inputs may be transmitted to an appropriate network element for further processing, such as to modify and register images. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1000. The computing device 1000 may be include depth cameras, such as stereoscopic camera systems, infrared camera systems, RGB camera systems, touchscreen technology, and combinations of these, for gesture detection and recognition. Additionally, the computing device 1000 may include accelerometers or gyroscopes (e.g., as part of an inertia measurement unit (IMU)) that allow detection of motion. In some examples, the output of the accelerometers or gyroscopes may be used by the computing device 1000 to render immersive augmented reality or virtual reality.

The power supply 1016 may include a hard-wired power supply, a battery power supply, or a combination thereof. The power supply 1016 may provide power to the computing device 1000 to allow the components of the computing device 1000 to operate.

The presentation component(s) 1018 may include a display (e.g., a monitor, a touch screen, a television screen, a heads-up-display (HUD), other display types, or a combination thereof), speakers, and/or other presentation components. The presentation component(s) 1018 may receive data from other components (e.g., the GPU(s) 1008, the CPU(s) 1006, DPUs, etc.), and output the data (e.g., as an image, video, sound, etc.).

### Example Data Center

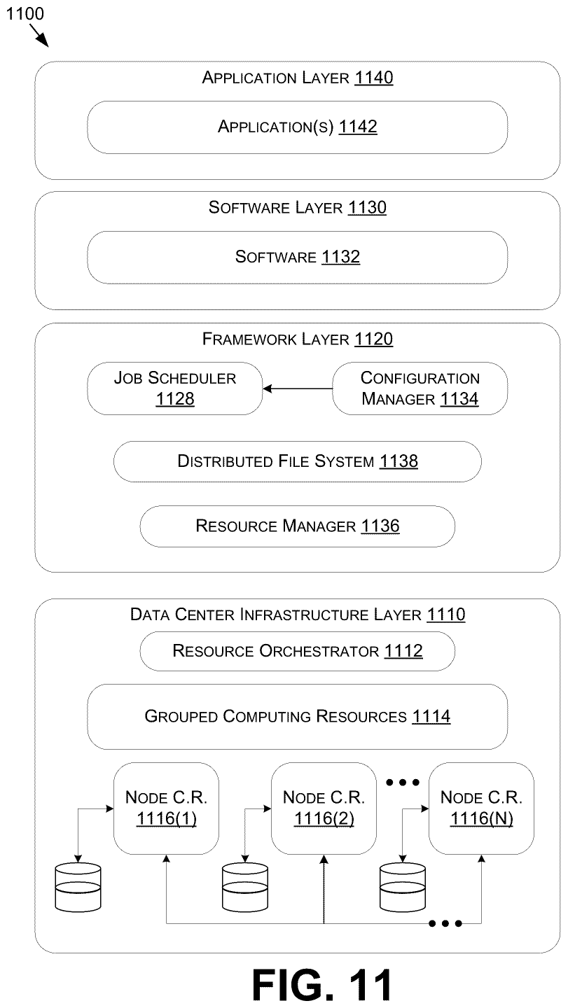

FIG. 11 illustrates an example data center 1100 that may be used in at least one embodiments of the present disclosure, such as to implement the systems 100, 200 in one or more examples of the data center 1100. The data center 1100 may include a data center infrastructure layer 1110, a framework layer 1110, a software layer 1130, and/or an application layer 1140.

As shown in FIG. 11, the data center infrastructure layer 1110 may include a resource orchestrator 1112, grouped computing resources 1114, and node computing resources (“node C.R.s”) 1116(1)-1116(N), where “N” represents any whole, positive integer. In at least one embodiment, node C.R.s 1116(1)-1116(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1116(1)-1116(N) may correspond to a server having one or more of the above-mentioned computing resources. In addition, in some embodiments, the node C.R.s 1116(1)-1116(N) may include one or more virtual components, such as vGPUs, vCPUs, and/or the like, and/or one or more of the node C.R.s 1116(1)-1116(N) may correspond to a virtual machine (VM).

In at least one embodiment, grouped computing resources 1114 may include separate groupings of node C.R.s 1116 housed within one or more racks (not shown), or many racks housed in data centers at various geographical locations (also not shown). Separate groupings of node C.R.s 1116 within grouped computing resources 1114 may include grouped compute, network, memory or storage resources that may be configured or allocated to support one or more workloads. In at least one embodiment, several node C.R.s 1116 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1112 may configure or otherwise control one or more node C.R.s 1116(1)-1116(N) and/or grouped computing resources 1114. In at least one embodiment, resource orchestrator 1112 may include a software design infrastructure (SDI) management entity for the data center 1100. The resource orchestrator 1112 may include hardware, software, or some combination thereof.

In at least one embodiment, as shown in FIG. 11, framework layer 1110 may include a job scheduler 1118, a configuration manager 1134, a resource manager 1136, and/or a distributed file system 1138. The framework layer 1110 may include a framework to support software 1132 of software layer 1130 and/or one or more application(s) 1142 of application layer 1140. The software 1132 or application(s) 1142 may respectively include web-based service software or applications, such as those provided by Amazon Web Services, Google Cloud and Microsoft Azure. The framework layer 1110 may be, but is not limited to, a type of free and open-source software web application framework such as Apache Spark™ (hereinafter “Spark”) that may utilize distributed file system 1138 for large-scale data processing (e.g., “big data”). In at least one embodiment, job scheduler 1118 may include a Spark driver to facilitate scheduling of workloads supported by various layers of data center 1100. The configuration manager 1134 may be capable of configuring different layers such as software layer 1130 and framework layer 1110 including Spark and distributed file system 1138 for supporting large-scale data processing. The resource manager 1136 may be capable of managing clustered or grouped computing resources mapped to or allocated for support of distributed file system 1138 and job scheduler 1118. In at least one embodiment, clustered or grouped computing resources may include grouped computing resource 1114 at data center infrastructure layer 1110. The resource manager 1136 may coordinate with resource orchestrator 1112 to manage these mapped or allocated computing resources.

In at least one embodiment, software 1132 included in software layer 1130 may include software used by at least portions of node C.R.s 1116(1)-1116(N), grouped computing resources 1114, and/or distributed file system 1138 of framework layer 1110. One or more types of software may include, but are not limited to, Internet web page search software, e-mail virus scan software, database software, and streaming video content software.

In at least one embodiment, application(s) 1142 included in application layer 1140 may include one or more types of applications used by at least portions of node C.R.s 1116(1)-1116(N), grouped computing resources 1114, and/or distributed file system 1138 of framework layer 1110. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments, such as to train, configure, update, and/or execute machine learning models 104, 204.

In at least one embodiment, any of configuration manager 1134, resource manager 1136, and resource orchestrator 1112 may implement any number and type of self-modifying actions based on any amount and type of data acquired in any technically feasible fashion. Self-modifying actions may relieve a data center operator of data center 1100 from making possibly bad configuration decisions and possibly avoiding underutilized and/or poor performing portions of a data center.

The data center 1100 may include tools, services, software or other resources to train one or more machine learning models (e.g., to implement the learning system 116, to train or update the policy network 124 and the discriminator 114, etc.) or predict or infer information using one or more machine learning models according to one or more embodiments described herein. For example, a machine learning model(s) may be trained by calculating weight parameters according to a neural network architecture using software and/or computing resources described above with respect to the data center 1100. In at least one embodiment, trained or deployed machine learning models corresponding to one or more neural networks may be used to infer or predict information using resources described above with respect to the data center 1100 by using weight parameters calculated through one or more training techniques, such as but not limited to those described herein.

In at least one embodiment, the data center 1100 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or perform inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1000 of FIG. 10—e.g., each device may include similar components, features, and/or functionality of the computing device(s) 1000. In addition, where backend devices (e.g., servers, NAS, etc.) are implemented, the backend devices may be included as part of a data center 1100, an example of which is described in more detail herein with respect to FIG. 11.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1000 described herein with respect to FIG. 10. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. A processor, comprising:
one or more circuits to:
determine, using a machine learning model and based at least on a humanoid state, a body shape, and task-related features, an action for a first human character in a first simulated environment,
wherein the task-related features include an environmental feature and a first trajectory.

2. The processor of claim 1, wherein
the machine learning model is updated to cause at least one of a plurality of second human characters to move according to a respective trajectory within a second simulated environment based at least on:
a first reward determined according to differences between simulated motion of the at least one of the plurality of second human characters and motion data for locomotion sequences determined from movements of real-life humans; and
a second reward for the machine learning model causing the at least one of the plurality of second human characters to move according to a respective trajectory based at least on a distance between the at least one of the plurality of second human characters and the respective trajectory.

3. The processor of claim 1, wherein:
the environmental feature comprises at least one of a height map for the simulated environment and a velocity map for the simulated environment; and
the first trajectory comprises 2-dimensional (2D) waypoints.

4. The processor of claim 1, wherein the one or more circuits are to:
transform, using a task feature processor, the environmental features into a latent vector; and
compute, using an action network, the action based at least on the humanoid state, the body shape, and the latent vector.

5. The processor of claim 4, wherein:
the task feature processor comprises a convolution neural network (CNN); and
the action network comprises a multilayer perceptron (MLLP).

6. The processor of claim 1, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

7. A processor, comprising:
one or more circuits to:
generate a simulated environment; and
update a machine learning model to cause at least one of a plurality of human characters having a plurality of body shapes to move according to a corresponding trajectory within the simulated environment as conditioned on a respective body shape, the machine learning model being updated by:
determining a first reward for the machine learning model causing a respective human character to move according to differences between simulated motion of the respective human character and motion data for locomotion sequences determined from movements of a respective real-life human;
determining a second reward for the machine learning model causing the respective human character to move according to a respective trajectory based at least on a distance between the respective human character and the respective trajectory; and
updating the machine learning model using the first reward and the second reward.

8. The processor of claim 7, wherein the plurality of human characters having the different body shapes are generated by randomly sampling a set of body shapes.

9. The processor of claim 7, wherein randomly sampling the set of body shapes comprises randomly sampling genders and randomly sampling body types.

10. The processor of claim 7, wherein the one or more circuits are to:
determine an initial body state of at least one of the plurality of human characters by randomly sampling a set of body states; and
determine an initial position of the at least one of the plurality of human characters by randomly sampling a set of valid starting points in the simulated environment.

11. The processor of claim 7, wherein generating the simulated environment comprises randomly sampling a set of simulated environments that comprises terrains with different terrain heights.

12. The processor of claim 7, wherein the one or more circuits are to generate the trajectory, wherein generating the trajectory comprises randomly sampling a set of trajectories, the set of trajectories having different velocities and turn angles.

13. The processor of claim 7, wherein the machine learning model is updated using goal-conditioned reinforcement learning.

14. The processor of claim 7, wherein:
updating the machine learning model to cause at least one of the plurality of human characters to move according to the respective trajectory within the simulated environment comprises determining a penalty for an energy consumed by the machine learning model in causing the at least one of the plurality of human characters to move according to the respective trajectory, the energy comprising a joint torque and a joint angular velocity; and
updating the machine learning model using the first reward, the second reward, and the penalty.

15. The processor of claim 7, wherein:
updating the machine learning model to cause at least one of the plurality of human characters to move according to a respective trajectory within the simulated environment comprises determining a motion symmetry loss for the simulated motion of the at least one of the plurality of human characters; and
updating the machine learning model using the first reward, the second reward, and the motion symmetry loss.

16. The processor of claim 7, wherein updating the machine learning model to cause at least one of the plurality of human characters to move according to a trajectory within the simulated environment comprises determining that a termination condition has been satisfied, the termination condition comprising one of:
a first human character of the plurality of human characters colliding with a second human character of the plurality of human characters;
the first human character colliding with an object of the simulated environment; or
the first human character colliding with a terrain of the simulated environment.

17. The processor of claim 7, wherein the processor is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system implemented using an edge device;
a system implemented using a robot;
a system for performing conversational AI operations;
a system for performing generative AI operations using a large language model (LLM);
a system for generating synthetic data;
a system incorporating one or more virtual machines (VMs);
a system implemented at least partially in a data center; or
a system implemented at least partially using cloud computing resources.

18. A method, comprising:
determining, using a machine learning model and based at least on a humanoid state, a body shape, and task-related features, an action for a first human character in a first simulated environment,
wherein the task-related features include an environmental feature and a first trajectory.

19. The method of claim 18, further comprising:
updating the machine learning model to cause at least one of a plurality of human characters to move according to a respective trajectory within a second simulated environment based at least on:
a first reward determined according to differences between simulated motion of at least one of the plurality of human characters and motion data for locomotion sequences determined from movements of real-life humans; and
a second reward for the machine learning model causing at least one of the plurality of human characters to follow a respective trajectory based at least on a distance between the at least one of the plurality of human characters and the respective trajectory.

20. The method of claim 18, further comprising:
transforming, using a task feature processor, the environmental features into a latent vector; and
computing, using an action network, the action based at least on the humanoid state, the body shape, and the latent vector.
